(19) United States
(12) Patent Application Publication
(10) Pub. No.: US 2012/0214411 A1
(43) Pub. Date: Aug. 23, 2012

(54) System and method of near field communication tag presence detection for smart polling

(75) Inventor: Koby Levy, Bat-Yam (IL)

(73) Assignee: Texas Instruments

(21) Appl. No.: 12/932,286

(22) Filed: Feb. 23, 2011

(51) Int. Cl. H04B 5/00

(52) U.S. Cl. 455/41.1

(57) ABSTRACT

A system for detecting the presence of a near filed communication object includes a radiator configured to radiate a magnetic field from a near field communication reader device; a detector configured to detect a loading effect on the magnetic field caused by the near filed communication object; and a decision circuit configured to determine that the near field communication object is present based on the detected loading effect. Only once the presence of a nearby NFC object is detected will higher power-consuming communications take place. Accordingly a power-sensitive background polling feature can be implement within the NFC architecture.

### BACKGROUND

1. Field

The present invention relates generally to near field communication and, more particularly, to power saving within such an environment.

2. Description of Related Art

The use of portable electronic devices and mobile communication devices has increased dramatically in recent years. Moreover, the demand for mobile devices that allow users to conduct contactless transactions is increasing. Near Field Communication technology (NFC) enables mobile devices to act as an electronic data transaction device. As one example, NFC can be used to perform contactless financial transactions such as those requiring a credit card. The user may select credit card information stored in the mobile device and perform contactless payments in a quick way by “tapping” or “waving” the mobile device in front of a contactless reader terminal. A reader terminal can read the credit card information and process a financial transaction. NFC can be coupled with an UICC (Universal Integrated Circuit Card) chip card used in mobile terminals in GSM (Global System for Mobile), UMTS (Universal Mobile Telecommunications System) or other networks to provide contactless payment transactions.

NFC technology on the other hand is being used in a wide array of applications including “fast-lane” payment at gas stations and supermarkets, for transit payments, and more. The mobile phone industry including governments have also moved forward in delivering services such as credit-card payments, Mobile Time Reporting, Smart Parking, Smart Theater for tickets with smart posters for information distribution, Information Tags in Restaurants for payment and ordering using hand-held devices, enabling Buses and Bus Stops with information and tickets, etc. This technology is already being used for services such as mobile ticketing and used to replace plastic credit and debit cards in consumers' pockets around the world.

One shortcoming, however, is unnecessary power consumption resulting in excessive battery drain, which is especially more sever in platforms that wish to enable automatic (i.e., non-user initiated) transactions requiring the NFC to perform “background polling”. The market desires as small an antenna as possible which results in a need to increase the antenna drive power and hence, power consumption, to achieve a desired link performance. Also, legacy technology standards result in relatively long activity thereby further increasing power consumption. Some solutions in the marketplace implement a “perceived” background polling each time a phone's display is turned on. There remains the need however for an improved method of reducing power regardless of whether the device implements perceived background polling or not.

### BRIEF SUMMARY

Embodiments of the present invention relate to a system and method for background polling for objects that can participate in near filed communication transactions. A system for detecting the presence of a near filed communication object includes a radiator configured to radiate a magnetic field from a near field communication reader device; a detector configured to detect a loading effect on the magnetic field caused by the near filed communication object; and a decision circuit configured to determine that the near field communication object is present based on the detected loading effect. In addition, a second order algorithm can be implemented to further distinguish the presence of NFC devices in the vicinity from other loading artifacts. Only once the presence of a nearby NFC object is detected will higher power-consuming communications take place. Accordingly a power-sensitive background polling feature can be implement within the NFC architecture.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of embodiments of the invention are illustrated by way of example, and not by way of limitation, in the accompanying drawings, wherein:

FIG. 1 depicts a graph of a polling method using standard polling techniques defined in the NFC protocols.

FIG. 2 depicts a graph of a smart probing technique for detecting the presence of NFC objects in accordance with the principles of the present invention.

FIG. 3 depicts a NFC-capable device that is configured to sense the presence of NFC objects in accordance with the principles of the present invention.

FIG. 4 depicts a flowchart of an exemplary method of sensing the presence of NFC objects in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the description that follows embodiments of the present invention are explained with reference to NFC technology. However, other contactless proximity/vicinity technologies are encompassed as well such as those complying with ISO 14443, JIS 6319-4, ISO15693, ISO18092/ECMA-340, for example. Also, the power saving benefit of the present invention is highlighted in some places. In addition, there is also coexistence benefits that are derived from embodiments of the present invention. Within multi-radio technology devices (e.g., integration of Bluetooth, GPS, WiFi, NFC, etc) the reduced NFC activity duty-cycle allows a reduced interference period and allows scheduling based solutions.

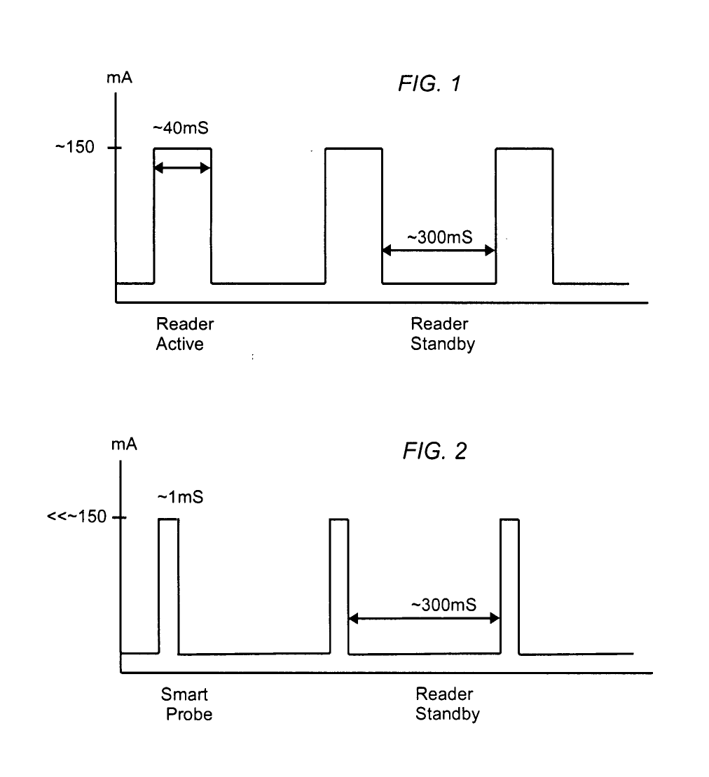

FIG. 1 depicts a graph of a polling method using standard polling techniques defined in the NFC protocols. The NFC standard defines a poll mode as the initial mode of an NFC device when it generates a carrier and probes, or polls, for nearby tags, devices, or objects. Such a mode involves a relatively high-power continuous-wave transmission for a long period of time (defined as “Guard Time” by the NFC Forum Standards), followed by transmission of a polling command (according to specific card/tag technology which is being searched). For example, such a polling mode would consume about 150 mA for between 5 and 25 mS depending on the antenna geometry and the technology of the NFC object (e.g., A, B, and F technologies that are defined by the NFC forum as well as legacy contactless proximity/vicinity cards/tags that are out of the NFC forum's scope such as B′, defined by Innovatron, and Vicinity card technology, defined by ISO 15693). As a result, polling for all possible technologies “technology detection” activity as defined by the NFC Forum's activity specification) might result in a poll of about 40 mS in duration. Using the above numbers, results in about 6 mA of average current consumption (assuming a single detection technology polling event), performed once a second. As shown in FIG. 1, there is a polling window of about 40 mS and then a standby period of about 300 mS. If a standby period of about 300 mS is assumed then the average current draw is about 18-20 mA (rather than 6 mA) results. During the active period current is being consumed while only a negligible amount is consumed during the standby period. However, for portable devices, this power consumption is considerable and explains why background polling, as shown in FIG. 1, is unfeasible. By “background polling”, we mean that a NFC device can search for the presence of nearby NFC objects without explicit initiation by the user. Even perceived background polling in which polling is performed whenever any activity is triggered by the user (e.g., the screen is turned on) consumes excessive amount of power.

FIG. 2 depicts a graph of a smart probing technique for detecting the presence of NFC objects in accordance with the principles of the present invention. In this figure, a smart probe occurs for only 1 mS between each of the 300 mS standby periods (alternatively, the standby period can be greater in length such as about 1 second depending on the specific technology). Such a probing technique would use considerably less power than the technique of FIG. 1. The power for each probe can be less than 150 mA because the probe does not require the full power signal that is used to accomplish polling (because the transmit level is only used for the sake of probing a vicinity for a remote device rather than for the device to be able to receive properly and energize itself from the power transferred by the induced field). In fact, the power usage of the technique of FIG. 2 would be low enough to allow many portable devices to implement background polling to discover nearby NFC objects. In the system of FIG. 2, the typical polling method of about 40 mS would be initiated only once the presence of a nearby NFC object is detected.

When an alternating current circulates in a coil of wire, two types of fields are produced: radiating and non-radiating. If the wire is small compared to the wavelength, very little energy can propagate away from the inductor in the radiating field, and the movement of energy is predominantly contained in the non-radiating field, called the reactive near field. It is called this because unless some of the energy is taken of the field by loading it, the energy is re-absorbed by the source instead of radiating out to free space. It is the reactive near field that is used by NFC.

A way to load the reactive near field is to place another inductor in proximity to the field so that the changing magnetic flux passes through the other inductor, causing a terminal voltage. The amount of coupling between the two inductors that is achieved is called the mutual inductance of the inductor pair. Instead of using this phenomenon to provide a protocol communication that energizes the other NFC device and communicating with it. (i.e., the high power consumption technique of FIG. 1), embodiments of the present invention detect the presence of a nearby NFC device simply by detecting its loading on the field generated by the polling NFC device. This detection of the nearby inductive load can occur in about 1 mS as shown in FIG. 2. Also, the detection of a nearby inductive load does not require the full 150 mA discussed above but can occur at lower currents such as 100 mA or even lower.

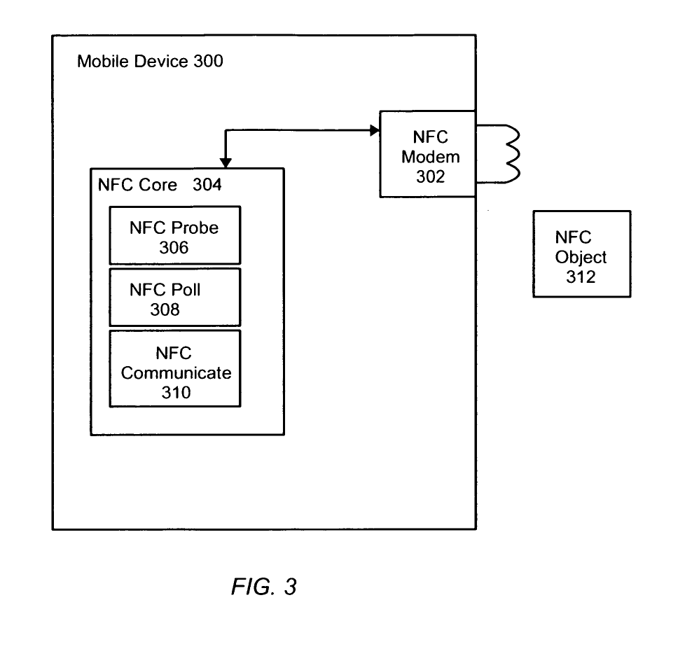

FIG. 3 depicts a NFC-capable device that is configured to sense the presence of NFC objects in accordance with the principles of the present invention. Not all the elements of the mobile device 300 are depicted so as not to obscure the inventive aspects of embodiments of the present invention. For example, if mobile device 300 is a cellular telephone then software, memory, a processor, and antenna would all be present in addition to those elements shown in FIG. 3. In accordance with the principles of the present invention, the mobile device 300 is capable of NFC transactions and communication with another NFC-enable object 312. These communications can occur with passive or active device and can be one-way or bi-directional without departing from the scope of the present invention. The device of FIG. 3 is exemplary only and the device may vary depending on implementation. For example, the NFC modem can be considered part of the NFC core (included in an NFC “PHY” subsystem that includes an Analog Front End block which is mostly analog in nature and performs somewhat of analog-digital conversion and an antenna interface as part of the transmission/reception. The NFC modem can perform the digital signal processing procedures that are required to convert the digital stream received from the AFE into digital distinguishable “0” and “1” logic bits and vice versa for the transmit path. The NFC PHY (e.g., modem and the NFC AFE) would perform the conversion of physical radio signals within the modem part while the rest of the NFC core would only get a trigger to wakeup in case the modem detected a loading effect that is greater that a configurable threshold. In other words, the NFC POLL and PROBE would mostly reside within the NFC PHY (and particularly within the modem chip) while the rest of the NFC Core would mostly control and activate the NFC PHY to perform its related activities.

The device 300 includes an NFC modem 302 which is the physical structure used to facilitate communication. However, the signals are evaluated and processed by an NFC core 304 that converts the physical radio signals into meaningful data which is transmitted or received by the device 300. With reference to embodiments of the present invention, the NFC core 304 includes one functional block labeled the NFC probe 306 and one functional block labeled NFC poll 308. The general communications and other features that are used to implement the NFC protocol are depicted as the functional block labeled NFC communications 310.

The NFC poll 308 block performs the above-described polling functionality that determines the capabilities of a nearby NFC device so that communications or a transaction can occur. The NFC probe 306 block is used to implement the probing timeline depicted in FIG. 2. In accordance with the principles of the present invention, the modem 302 is controlled so as to radiate a magnetic field having a particular resonant frequency. (e.g., for NFC, that frequency is about 13.56 MHz). The physical attributes of that radiating field are measured and analyzed by the NFC probe block 306 to determine if an NFC object 312 is nearby.

One of ordinary skill will recognize that there are functionally equivalent ways of determining the load of a nearby inductor on the magnetic field radiated by the mobile device 300. For example, the voltage across the radiating conductor can be measured at two different frequencies to determine if an object nearby is radiating at that frequency. A lower relative voltage at one frequency will indicate the presence of an inductor nearby radiating at that frequency as well. Also, the resonant frequency peak will shift somewhat when a similar resonant circuit is nearby. Additionally, the probe element could also operate so as to sense the change in current drawn from the NFC device by its antenna and its corresponding matching circuit because with NFC devices in the vicinity, this current will change. Thus, if the radiating peak shifts downward slightly from 13.56 MHz, then that likely indicates that an NFC object 312 is nearby.

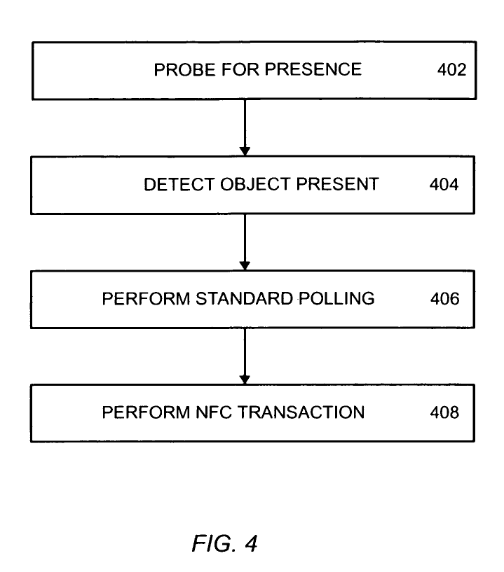

FIG. 4 depicts a flowchart of an exemplary method of sensing the presence of NFC objects in accordance with the principles of the present invention. In step 402, a mobile device probes for the presence of a nearby NFC object. This probing can be performed at short intervals (e.g., about 1 mS) and consume relatively small amount of current (e.g., less than about 75 mA). With this type of power consumption, the probing for nearby NFC device can be performed in the background without initiation by the user.

In step 404, if a nearby object is detected to be present, then step 406 is performed which initiates the standard polling steps in the NFC protocol. If, however, no nearby object was detected, then the probing repeats itself after a predetermined time period (e.g., 300 mS).

Once the polling steps take place, in step 406, the two NFC devices can communicate and thereby accomplish some NFC transaction, in step 408.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. Also, the term “exemplary” is meant to indicate that some information is being provided as an example only as is not intended to mean that that information is somehow special or preferred. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for detecting the presence of a near filed communication object, comprising:
radiating a magnetic field from a near field communication reader device;
detecting by the near filed communication reader device a loading effect on the magnetic field caused by the near filed communication object; and
determining by the near field communication reader device that the near field communication object is within communicating distance based on the detected loading effect.

2. The method of claim 1, further comprising:
polling the near field communication object, if determined to be within communicating distance.

3. The method of claim 1, further comprising:
repeating the radiating, detecting and determining steps periodically.

4. The method of claim 3 wherein repeating occurs about every 300 mS.

5. The method of claim 1, wherein radiating the magnetic field is performed for about 2 mS.

6. The method of claim 1, wherein radiating the magnetic field consumes about 150 mA.

7. The method of claim 1, wherein radiating the magnetic field consumes about 100 mA.

8. The method of claim 1, wherein radiating the magnetic field consumes less than 100 mA.

9. The method of claim 1, wherein detecting the loading effect involves detecting a change in voltage across a resonant circuit of the near field communication reader device.

10. The method of claim 1, wherein detecting the loading effect involves detecting a change in a resonant frequency of a resonant circuit of the near field communication reader device.

11. The method of claim 1, wherein radiating a magnetic field includes a resonant circuit with a resonant frequency of about 13.56 MHz.

12. A system for detecting the presence of a near filed communication object, comprising:
a radiator configured to radiate a magnetic field from a near field communication reader device;
a detector configured to detect a loading effect on the magnetic field caused by the near filed communication object; and
a decision circuit configured to determine that the near field communication object is present based on the detected loading effect.

13. The system of claim 12, further comprising:
a polling module configured to poll the near field communication object, if determined to be within communicating distance.

14. The system of claim 12, further comprising:
a timer configured to control probing for the near field communication object at repeated intervals without user initiation.

15. The system of claim 12, wherein the magnetic field is radiated for about 2 mS.

16. The system of claim 121, wherein the radiator consumes about 150 mA when radiating the magnetic field.

17. The system of claim 12, wherein the radiator consumes less than 100 mA when radiating the magnetic field.

18. The system of claim 12, wherein the detector is configured to detect a change in voltage across a resonant circuit of the near field communication reader device.

19. The system of claim 12, wherein the detector is configured to detect detecting a change in a resonant frequency of a resonant circuit of the near field communication reader device.

20. The system of claim 12, wherein the radiator includes a resonant circuit with a resonant frequency of about 13.56 MHz.
